(19) United States
(12) Patent Application Publication
(10) Pub. No.: US 2014/0265396 A1
(43) Pub. Date: Sep. 18, 2014

(54) GLOVED SUPPORT

(71) Applicant: Philip C. Jackson, Phoenix, AZ (US)

(72) Inventor: Philip C. Jackson, Phoenix, AZ (US)

(21) Appl. No.: 14/056,457

(22) Filed: Oct. 17, 2013

Related U.S. Application Data
(60) Provisional application No. 61/852,565, filed on Mar. 18, 2013.

(51) Int. Cl. F16M 13/04

(52) U.S. Cl. CPC F16M 13/04
USPC 294/149

(57) ABSTRACT

A glove bearing either hook or loop material supports a unit having a visually perceivable display by detachably attaching the hook or loop material on the glove with mating hook or loop material on the backside of the unit.

### CROSS REFERENCE TO RELATED APPLICATION

The present application includes subject matter disclosed in and claims priority to a provisional application entitled “GRIP FREE PRESENTATION DEVICE SUPPORTER GLOVE” filed Mar. 18, 2013 and assigned Ser. No. 61/852,565 describing an invention made by the present inventor.

### BACKGROUND OF THE INVENTION

1. Field of the Invention

The present invention relates to hand-held supports and, more particularly, to a gloved support for a visually perceivable display.

2. Description of Related Prior Art

Laptops, tablets, and smartphones are often used to provide visually perceivable written matter. When these items rest upon a desk, lectern or other supporting surface, viewing same and scrolling the display is relatively easy and convenient.

When written material displayed on a laptop, tablet or smartphone is referred to or read by a lecturer or speaker when no lectern is available, the unit must be held by one hand. Usually, the unit is supported on the palm and fingers of the speaker and the thumb rests on the unit and presses it against the palm and fingers to hold it steady and prevent slipping. Depending upon the weight of the unit and the manual strength of a user, the user's thumb may become fatigued and continued use will become difficult.

### SUMMARY OF THE INVENTION

The present invention is directed to a glove having elements for detachably attaching a laptop, tablet, smartphone or similar unit. Depending upon the location of the elements, the unit may be supported upon the forefinger and thumb, the palm of the glove or variations thereof. One part of a hook and loop fastener is secured to one or more locations on the glove and the other part of the hook and loop fastener is secured to the unit to be supported. Thereby, attachment and detachment of the unit with the glove is facile.

It is therefore a primary object of the present invention to provide a gloved support for a visually perceivable display.

Another object of the present invention is to provide a gloved support for detachably attaching a visually perceivable display to the glove.

Still another object of the present invention is to provide a gloved support for a visually perceivable display that may be useable with either hand of a speaker.

Yet another object of the present invention is to provide an easily transportable gloved support for a visually perceivable display.

A further object of the present invention is to provide a gloved support for a visually perceivable display useable by a speaker at any location.

A still further object of the present invention is to provide a gloved support detachably attachable to an item to be supported without the need to grip the item.

A yet further object of the present invention is to provide a method for mounting a visually perceivable display on the hand of a speaker.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a gloved support mounted on a hand for supporting a tablet;

FIG. 2 is an isometric view of an embodiment of the gloved support;

FIG. 3 illustrates the hook or loop material of a hook and loop fastener attached to the rear of the tablet shown in FIG. 1;

FIG. 3A is a side view of the tablet showing the hook or loop material mounted at the rear thereof;

FIG. 4 illustrates a variant of the configuration of the hook or loop material attached to a glove;

FIG. 5 illustrates a further variant of the hook or loop material mounted on a glove;

FIG. 6 illustrates a yet further variant of the hook or loop material mounted on a glove;

FIG. 7 illustrates a tablet detachably attachable to the palm of a user's hand; and

FIG. 8 illustrates the hook or loop material attached to the glove for supporting the tablet shown in FIG. 7.

### DESCRIPTION OF THE PREFERRED EMBODIMENT

Many speakers and lecturers use laptops, tablets or even smartphones for displaying their talk or notes/cues for their talk. When a lectern or table is available to support one of these units, the lecturer or speaker has limited mobility during the talk. To provide mobility, the lecturer or speaker has to grip the unit to move it as he/she moves. Such gripping becomes tiring as a function of both the weight and configuration of the unit.

Referring to FIG. 1, there is shown a conventional tablet 10 having a viewable screen or display 12. As is well known, a writing having letters of essentially any reasonable size may be viewed on the display. This writing may be a speech, notes or cues for use by a lecturer or other speaker. Various other images can also be displayed for purposes useful to the lecturer or speaker.

To use a laptop, tablet or smartphone, it has to be gripped by at least one hand. Usually, the fingers of one hand are placed behind the unit and the thumb is located along a front edge. Depending upon the weight of the unit along with the strength and stamina of the user's thumb, such support could be tiring and difficult to a greater or lesser degree.

Still referring to FIG. 1, support for tablet 10 is provided by a gloved hand 14. As shown in FIG. 2, glove 16 includes a wrist section 18 that extends about wrist 20 of the user. Snaps 22, 24 may be used to secure the wrist section about the wrist of the user. A strip 26 of hook material or loop material of a hook and loop fastener of the type sold under the trademark Velcro®, is attached to thumb 28 of glove 16. A similar strip 30 of hook or loop material (the same as strip 26), is attached to finger 32.

As shown in FIGS. 3 and 3A, a section 34 of hook or loop material is adhered to rear surface 36 of tablet 10. It is to be understood that if strips 26, 30 are of loop material, section 34 is of hook material or the reverse. Thereby, tablet 10 can be detachably attached to the gloved hand by engaging section 34 with strips 26, 30.

As illustrated in FIG. 1, by placing tablet 10 adjacent gloved hand 14 to locate section 34 in contact with strips 26, 30, the tablet will become detachably attached to the gloved hand. Moreover, the tablet can be easily oriented for the best viewing angle by the user. It is to be noted that no gripping of the tablet is necessary. The tablet can be re-oriented relative to the gloved hand as best befits the lecturer or speaker while he/she may move his/her arm while standing or walking in order to best view the material on display 12.

As shown in FIG. 2, glove 16 only includes a thumb and two fingers. This permits ventilation of the uncovered parts of the hand for the comfort of the lecturer or speaker. It is to be understood that for the configuration shown in FIGS. 1 and 2, even the second finger 38 may be omitted from the glove.

Referring to FIG. 4, there is shown a right hand glove 40 having only a thumb 42 and a forefinger 44. The glove may include a wrist section 46 to provide additional support for the glove. A plurality of strips of hook or loop material may be attached to the glove. For example, a strip 48 extends along thumb 42. Another strip 50 extends along forefinger 44. These strips may be joined by a further strip 52. Another strip 54 may extend about wrist section 46. It may be joined with strip 48 via further strips 56 and 58. Thereby, the significant part of glove 40 includes either hook or loop material for detachably engaging with section 34 of the other of hook or loop material disposed on the rear of tablet 10. By inspection, the plurality of strips secured to glove 40 permits a wide degree of variation in the manner in which tablet 10 may be detachably attached to the glove to provide the requisite support and stability preferred by a user.

Referring to FIG. 5, there is shown another variant of the glove. Glove 62 includes a forefinger 64 and a thumb 66. A strip 68 of hook or loop material is disposed on the inside surface of thumb 66. A further strip 70 of hook or loop material is attached to palm section 72 of glove 62. A yet further strip 74 of hook or loop material is attached to wrist section 76 of glove 62. With this arrangement, the rear of tablet 10 is securely attached to strips 68, 70 and 74 to permit a user to have his/her hand extended behind tablet 10.

Referring to FIG. 6, there is shown a conventional glove 80 having snaps 82, 84 for securing wrist section 86 about the user's wrist. In this variant, hook or loop material extends along a significant part of the backside of the glove and along thumb 90 and forefinger 92. Such extended section of hook or loop material provides a user with various options in orienting the attachment of tablet 10 to glove 80.

FIG. 7 illustrates a tablet 10 detachably attached along the palm and thumb of a glove 100 worn by a user. More particularly, FIG. 8 illustrates the location of a strip 102 of hook or loop material attached along the top and inside surface of thumb 104. A strip 106 is attached to palm 108 of glove 100. As depicted by dashed lines 110, tablet 10 is detachably attached to strips 102 and 106 to provide the configuration illustrated in FIG. 7. It may be noted that for stability purposes, a partial forefinger 112 of the glove may exist to stabilize the glove on the user's hand.

In each of the above described gloves, less than all fingers of a glove are used. Such omissions have the benefit of cooling the hand to prevent sweating and other discomfort that may arise from using a glove. However, it is to be understood that a conventional glove configuration can be used for attaching the various hook or loop strips thereto. Additionally, each of the glove variants illustrated and described may be right-handed or left-handed. Such essentially duplicative configurations have been omitted for purposes of clarity and brevity.

I claim:

1. A gloved support for a visually perceivable display, said gloved support comprising:
(a) a glove for either the left hand or the right hand of a user;
(b) said glove including a thumb and at least a forefinger; and
(c) selected strips of either a hook or a loop material of a hook and loop fastener disposed on said forefinger and on said thumb for fastening with the other of said hook section or said loop section of the hook and loop fastener disposed on the display.

2. The gloved support as set forth in claim 1 wherein said glove does not include a middle finger, a ring finger or a little finger.

3. The gloved support as set forth in claim 2 wherein the forefinger of said glove is truncated.

4. The gloved support as set forth in claim 1 wherein said glove includes a snap for securing said glove about the wrist of a user.

5. A gloved support for a visually perceivable display, said gloved support comprising:
(a) a glove for either the left hand or the right hand of a user;
(b) said glove including a thumb and at least a forefinger; and
(c) selected strips of either a hook or a loop material of a hook and loop fastener disposed on said thumb, on the back of the hand and on said forefinger of said glove for fastening with the other of said hook or said loop material of said hook and loop fastener disposed on the display.

6. The gloved support as set forth in claim 5 wherein said glove does not include a middle finger, a ring finger or a little finger.

7. The gloved support as set forth in claim 6 wherein the forefinger of said glove is truncated.

8. The gloved support as set forth in claim 5 wherein said selected hook or loop material of said hook and loop fastener is disposed on the wrist of said glove.

9. A gloved support for a visually perceivable display, said gloved support comprising:
(a) a glove for either the left hand or the right hand of a user;
(b) said glove including a thumb and at least a forefinger; and
(c) selected strips of either a hook or a loop material of a hook and loop fastener disposed on said thumb and on the palm of said glove for fastening with the other of said hook or said loop material of the hook and loop fastener disposed on the display.

10. The gloved support as set forth in claim 9 wherein said glove does not include a middle finger, a ring finger or a little finger.

11. The gloved support as set forth in claim 10 wherein the forefinger of said glove is truncated.

12. The gloved support as set forth in claim 9 wherein said selected hook or loop material on said thumb is on the side of said thumb.
